(19) United States
(12) Patent Application Publication
(10) Pub. No.: US 2012/0130514 A1
(43) Pub. Date: May 24, 2012

(54) ATHLETIC PERFORMANCE RATING SYSTEM

(75) Inventors: Kristopher L. Homsi, Beaverton, OR (US); Eric Hakeman, Beaverton, OR (US); David H. Annis, Charlotte, NC (US)

(73) Assignee: Nike International Ltd., Beaverton, OR (US)

(21) Appl. No.: 13/264,537

(22) PCT Filed: Apr. 16, 2010
(86) PCT No.: PCT/US10/31438

§ 371 Date: Jan. 4, 2012

Related U.S. Application Data
(60) Provisional application No. 61/169,993, filed on Apr. 16, 2009.
(60) Provisional application No. 61/174,853, filed on May 1, 2009.

(51) Int. Cl. G06F 19/00

(52) U.S. Cl. 700/91

(57) ABSTRACT

In one embodiment, the present invention is directed to an athleticism rating method for normalizing and more accurately comparing overall athletic performance of at least two athletes. Each athlete completes at least two different athletic performance tests. Each test is designed to measure a different athletic skill that is needed to compete effectively in a defined sport. The results from each test for a given athlete are normalized by comparing the test results to a database providing the distribution of test results among a similar class of athletes and then assigning each test result a point number based on that test result's percentile among the distribution of test results. Combining the point numbers derived from the at least two different athletic performance tests for an athlete produces an athleticism rating score representing the overall athleticism of each athlete.

### CROSS-REFERENCE TO RELATED APPLICATIONS

This application claims the benefit of U.S. patent application Ser. No. 61/169,993, filed Apr. 16, 2009 and entitled “Athletic Performance Rating System” (attorney docket number NIKE.146269) and U.S. patent application Ser. No. 61/174,853, filed May 1, 2009 and entitled “Athletic Performance Rating System” (attorney docket number NIKE.148870).

This application is related by subject matter to U.S. Provisional Patent Application No. 61/148,293, filed Jan. 29, 2009, entitled “Athletic Performance Rating System”, U.S. patent application Ser. No. 61/149,251, filed Feb. 2, 2009 and entitled “Athletic Performance Rating System” (attorney docket number NIKE.146269) and U.S. patent application Ser. No. 12/559,082 filed Sep. 14, 2009 and entitled “Athletic Performance Rating System” (attorney docket number NIKE.146275).

### FIELD OF THE INVENTION

The present disclosure relates to athleticism ratings and related performance measuring systems for use primarily with athletic activities such as training, evaluating athletes, and the like.

### BACKGROUND OF THE INVENTION

Athletics are extremely important in our society. In addition to competing against each other on the field, athletes often compete with each other off the field. For example, student athletes routinely compete with each other for a spot on a team, more playing time, or for a higher starting position. Graduating high school seniors are also in competition with other student athletes for coveted college athletic scholarships and the like. Also, amateur athletes in some sports often compete with each other for jobs as professional athletes in a particular sport. The critical factor in all of these competitions is the athletic performance, or athleticism, of the particular athlete, and the ability of that athlete to demonstrate or document those abilities to others.

Speed, agility, reaction time, and power are some of the determining characteristics influencing the athleticism of an athlete. Accordingly, athletes strive to improve their athletic performance in these areas, and coaches and recruiters tend to seek those athletes that have the best set of these characteristics for a particular sport.

To date, evaluation and comparison of athletes has been largely subjective. Scouts tour the country viewing potential athletes for particular teams, and many top athletes are recruited site unseen, simply by word of mouth. These methods for evaluating and recruiting athletes are usually hit or miss.

One method for evaluating and comparing athletes' athleticism involves having the athletes perform a common set of exercises and drills. Athletes that perform the exercises or drills more quickly and/or more accurately are usually considered to be better than those with slower or less accurate performance for the same exercise or drill. For example, “cone drills” are routinely used in training and evaluating athletes. In a typical “cone drill” the athlete must follow a pre-determined course between several marker cones and, in the process, execute a number of rapid direction changes, and/or switch from forward to backward or lateral running.

Although widely used in a large number of institutions (e.g., high schools, colleges, training camps, and amateur and professional teams), such training and testing drills usually rely on the subjective evaluation of the coach or trainer or on timing devices manually triggered by a human operator. Accordingly, they are inherently subject to human perception and error. These variances and errors in human perception can lead to the best athlete not being determined and rewarded.

Moreover, efforts to meaningfully compile and evaluate the timing and other information gathered from these exercises and drills have been limited. For example, while the fastest athlete from a group of athletes through a given drill may be determinable, these known systems do not allow that athlete to be meaningfully compared to athletes from all over the world that may not have participated in the exact same drill on the exact same day.

In basketball, for example, collegiate and high school athletes are judged on their ability to play in the National Basketball League (NBA) based at least in part on their performance in a pre-draft camp conducted by the NBA. At this camp, athletes are subjected to a series of tests that are intended to illustrate the abilities of each player so each NBA franchise can make an informed decision on draft day when selecting players.

While such tests provide each NBA franchise a snap shot of a given player's ability on a particular test, none of the tests are compiled such than an overall athleticism rating and/or ranking is provided. The test results are simply discrete data points that are viewed in a vacuum without considering each test in light of the other tests. Furthermore, such test scores provide little benefit to up-and-coming collegiate, high school, and youth athletes, as pre-draft test results are not easily scaled and cannot therefore be utilized by collegiate, high school, and youth athletes in judging their abilities and comparing their skills to prospective and current NBA players.

### SUMMARY OF THE INVENTION

Embodiments of the present invention relate to methods of rating the performance of an athlete. In one embodiment, the present invention is directed to an athleticism rating method for normalizing and more accurately comparing overall athletic performance of at least two athletes. Each athlete completes at least two different athletic performance tests. Each test is designed to measure a different athletic skill that is needed to compete effectively in a defined sport. The results from each test for a given athlete are normalized by comparing the test results to a database providing the distribution of test results among a similar class of athletes and then assigning each test result a point number based on that test result's percentile among the distribution of test results. Combining the point numbers derived from the at least two different athletic performance tests for an athlete produces an athleticism rating score representing the overall athleticism of each athlete.

When the defined sport is basketball, for example, the athletic performance tests may include measuring a no-step vertical jump height of an athlete, measuring an approach jump reach height of the athlete, measuring a sprint time of the athlete over a predetermined distance, and measuring a cycle time of the athlete around a predetermined course. The method may further include referencing the no-step vertical jump height, the approach jump reach height, the timed sprint, and the cycle time to at least one look-up table for use in generating the athleticism rating score. A scaling factor may also be applied to the calculated athleticism rating score of each athlete to allow the rating scores among a group of tested athletes to fall within a desired range.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWING

The present invention is described in detail below with reference to the attached drawing figures, wherein:

FIG. 1 illustrates a flow chart of an athleticism rating system in accordance with the principles of the present disclosure;

FIG. 2 illustrates a user interface of a data collection card for use with the athleticism rating method of FIG. 1;

FIG. 3 is a schematic representation of a testing facility and test configuration for use with the athleticism rating system of FIG. 1;

FIG. 4 is a perspective view of an athlete demonstrating a no-step vertical jump test in accordance with the principles of the present disclosure;

FIG. 5 is a perspective view of a test apparatus for use in determining a max touch reach height in accordance with the principles of the present disclosure;

FIG. 6 is a perspective view of the test apparatus of FIG. 5 showing an athlete demonstrating a max-touch test in accordance with the principles of the present disclosure;

FIG. 7 is a schematic representation of a test setup for use in determining lane agility in accordance with the principles of the present disclosure;

FIG. 8 is a perspective view of an athlete demonstrating a two-handed heave of a medicine ball for use in determining a kneeling power ball toss in accordance with the principles of the present disclosure;

FIG. 9 is a perspective view of an athlete performing a multi-stage hurdle test in accordance with the principles of the present disclosure;

FIG. 10 is an exemplary performance guide in accordance with the principles of the present disclosure;

FIG. 11 is a table showing one example of data collected during a test event for basketball;

FIG. 12 is an exemplary look-up table for a female athlete's no-step vertical jump for basketball;

FIG. 13 is an exemplary graph showing no-step vertical jump data observed in the field for a number of female athletes tested for basketball;

FIG. 14 is a table showing “w-scores” for an exemplary female athlete applicable to basketball;

FIG. 15 is a table showing “w-scores” for an exemplary female athlete applicable to basketball;

FIG. 16 is a flow diagram illustrating an exemplary method for generating an athleticism rating score, in accordance with an embodiment of the present invention;

FIG. 17 is a block diagram of an exemplary computing environment suitable for use in implementing embodiments of the present invention;

FIG. 18 is an exemplary look-up table in accordance with the principles of the present disclosure for use in generating an athleticism rating for fastpitch softball;

FIG. 19 is a table showing one example of data collected during a test event for fastpitch softball;

FIG. 20 is an exemplary look-up table for a female athlete's vertical jump for fastpitch softball;

FIG. 21 is an exemplary graph showing vertical jump data observed in the field for a number of female athletes tested for fastpitch softball;

FIG. 22 is a table showing “w-scores” for an exemplary female athlete applicable to fastpitch softball;

FIG. 23 is a table showing “w-scores” for an exemplary female athlete applicable to fastpitch softball;

FIG. 24 is a schematic representation of a test setup for use in determining agility in accordance with the principles of the present disclosure;

FIG. 25 is a schematic representation of a test setup for use in determining recovery ability in accordance with the principles of the present disclosure; and

FIG. 26 is a an exemplary look-up table for a female athlete's vertical jump for soccer

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention relate to methods of rating the performance of an athlete. In one embodiment, the present invention is directed to an athleticism rating method for normalizing and more accurately comparing overall athletic performance of at least two athletes. Each athlete completes at least two different athletic performance tests. Each test is designed to measure a different athletic skill that is needed to compete effectively in a defined sport. The results from each test for a given athlete are normalized by comparing the test results to a database providing the distribution of test results among a similar class of athletes and then assigning each test result a point number based on that test result's percentile among the distribution of test results. Combining the ranking numbers derived from the at least two different athletic performance tests for an athlete produces an athleticism rating score representing the overall athleticism of each athlete.

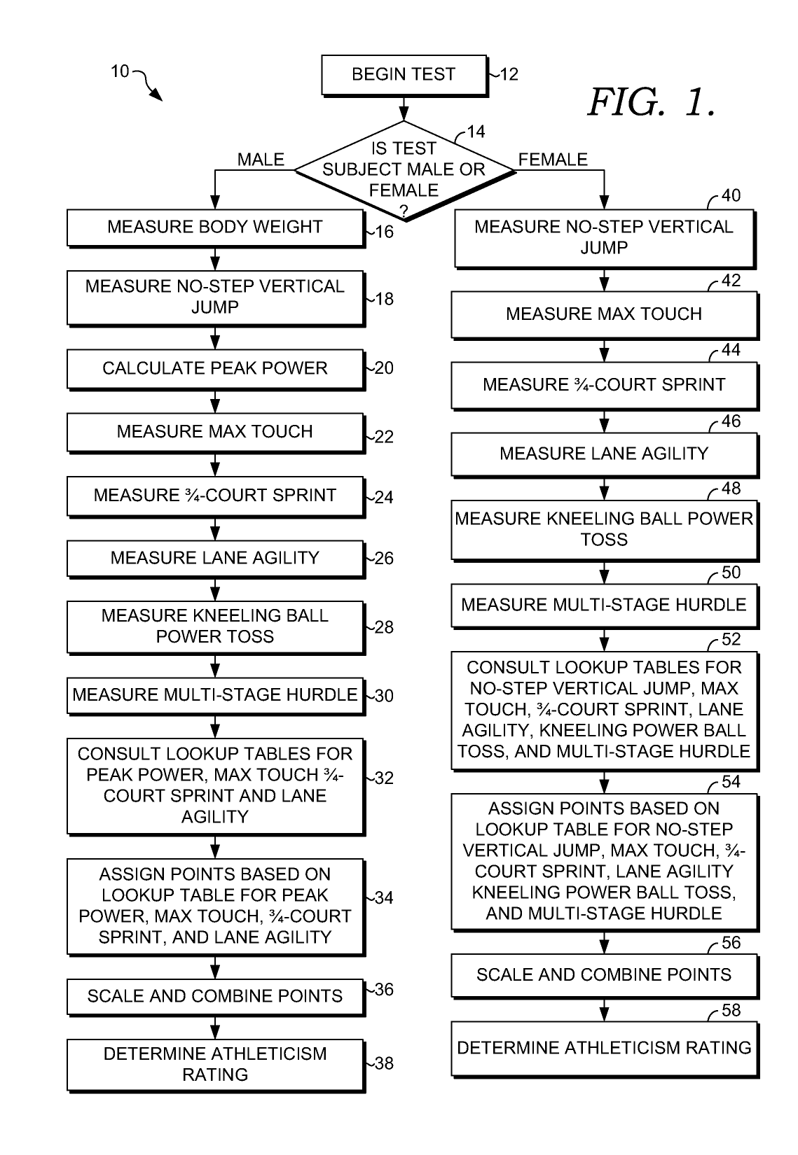

With particular reference to FIG. 1, a method 10 for rating athleticism is provided and includes conducting at least two different athletic tests designed to assess the athletic ability and/or performance of a given athlete by generating an overall athleticism rating score for the athlete.

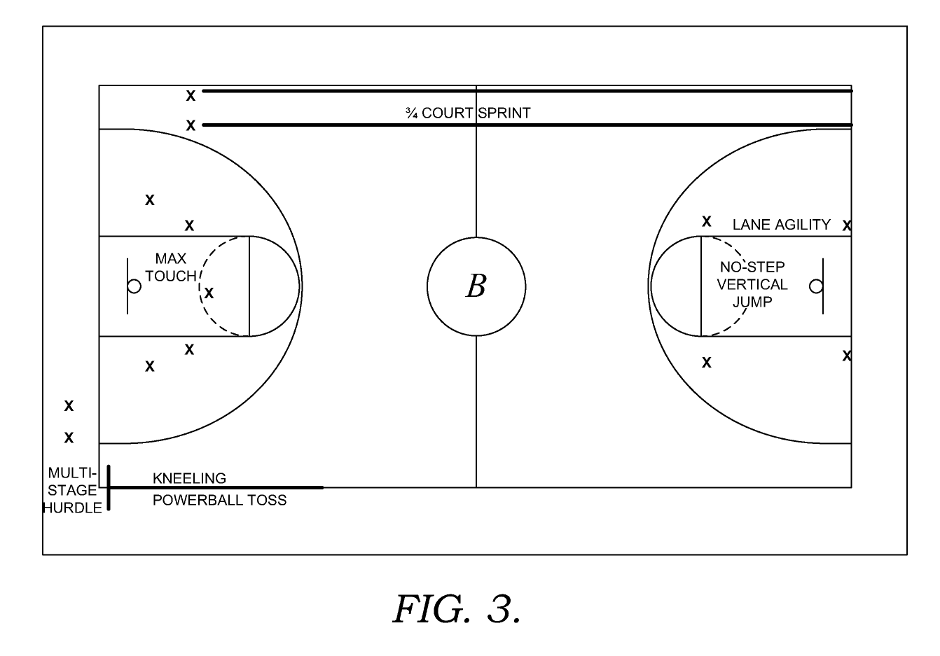

Each test is designed to measure a different athletic skill that is needed to compete effectively in a defined sport. For example, in the sport of basketball, the athleticism rating method 10 includes conducting four discrete tests, which may be used to determine a male athlete's overall athleticism rating. In another configuration, the athleticism rating method 10 includes conducting six discrete tests that may be used to determine a female athlete's overall athleticism rating, as it pertains to the sport of basketball. An exemplary test facility and configuration is schematically illustrated in FIG. 3. The test facility and equipment used in measuring and collecting test data may be of the type disclosed in Assignee's commonly owned U.S. patent application Ser. No. 11/269,161, filed on Nov. 7, 2005, the disclosure of which is incorporated herein by reference in its entirety.

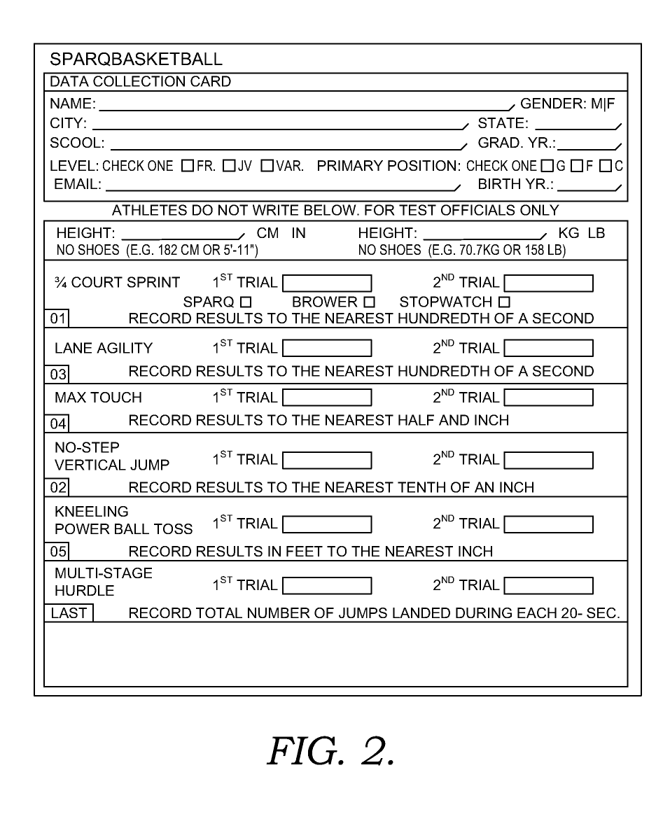

With continued reference to FIG. 1, the testing process for determining the overall athleticism of an athlete may be initiated at step 12 by first determining whether the subject athlete is male or female at step 14. If the subject athlete is male, the body weight of the athlete is measured at step 16 and may be recorded on a data collection card, as shown in FIG. 2. Following measurement of the body weight, a no-step vertical jump test is performed by the athlete at step 18.

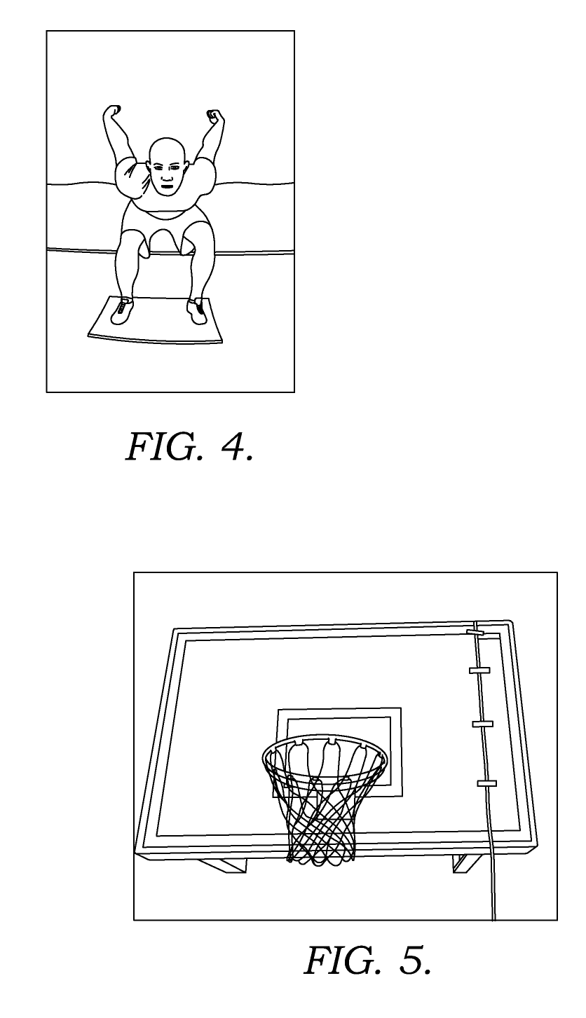

The no-step vertical jump test generally reveals an athlete's development of lower-body peak power and is performed on a court or other hard flat, level surface. The athlete performs a counter-movement vertical jump by squatting down and jumping up off two feet while utilizing arm swing to achieve the greatest height (FIG. 4). A measurement of the vertical jump may be recorded on the physical or electronic data collection card (FIG. 2).

Once the body weight and no-step vertical jump of the athlete are recorded on the data collection card, a peak power of the athlete may be calculated at step 20. The calculated peak power may also be displayed and recorded along with the body weight and no-step vertical jump of the athlete on the data collection card.

As described above, the no-step vertical jump measures the ability of an athlete in jumping vertically from a generally standing position. In addition to determining a no-step vertical jump (i.e., a jump from a generally motionless position), the athleticism rating method 10 also includes measuring an approach jump, which allows an athlete to move—either by running or walking—toward a target to assess the athlete's functional jumping ability.

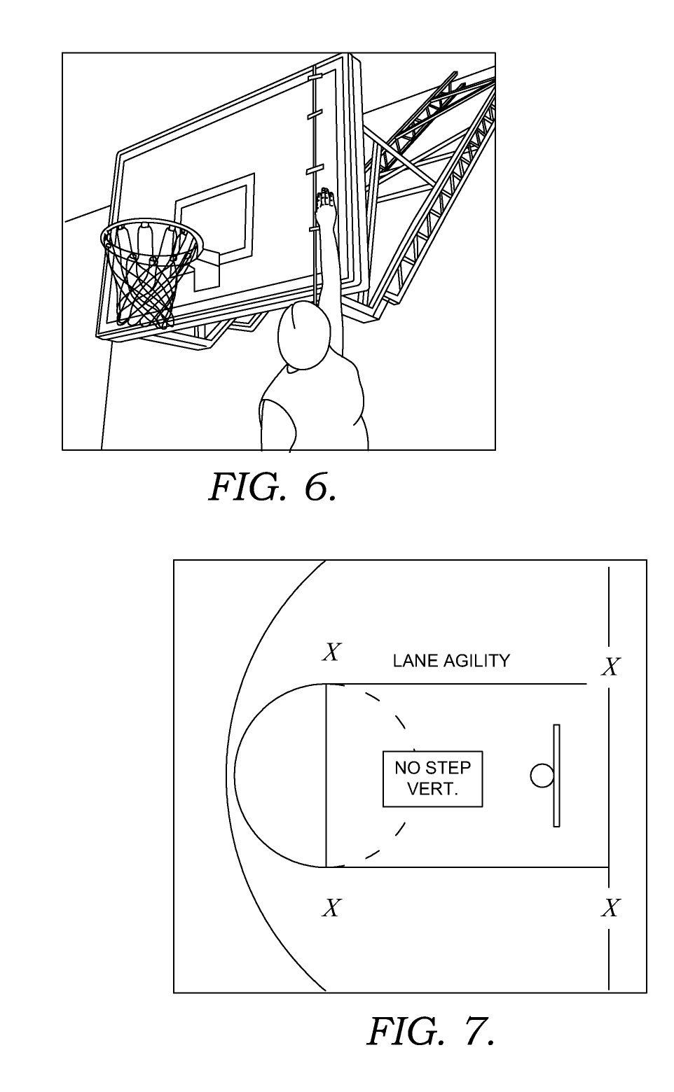

As shown in FIGS. 5 and 6, a scale such as, for example, a tape measure, may be fixed to a structure such as, for example, a backboard. Once the scale is attached to the backboard, the athlete is allowed to approach the scale from within a substantially fifteen-foot arc and jump from either one or two feet extending one arm up toward the scale to determine the highest reach above a floor. When the athlete approaches and then jumps off the floor, the approach jump reach height may be read either visually or by way of an electronic sensor based on the position of the athlete's hand relative to the scale and may be recorded at step 22 as a “max touch” of the athlete. As with the peak power, the max touch may be recorded on the data collection card of FIG. 2.

Following measurement of the approach jump reach height, the athlete may be subjected to a timed sprint over a predetermined distance. In one configuration, the athlete performs a sprint over approximately seventy-five feet, which is roughly equivalent to three-quarters of a length of a basketball court. The time in which the athlete runs the predetermined distance is measured at step 24 and may be recorded on the data collection card of FIG. 2.

With reference to FIG. 7, an agility of the athlete may be determined by timing the athlete as the athlete maneuvers through a predetermined course. In one configuration, the course is a substantially sixteen-foot by nineteen-foot box, which is roughly the same size as the “paint” or “box” of a basketball court. Timing the athlete's ability to traverse the paint provides an assessment as to the overall agility of the athlete. The athlete may be required to run a single cycle or multiple cycles around the box. A measurement of the time in which the athlete performs the cycles around the box may be measured at step 26 and recorded in the data collection sheet.

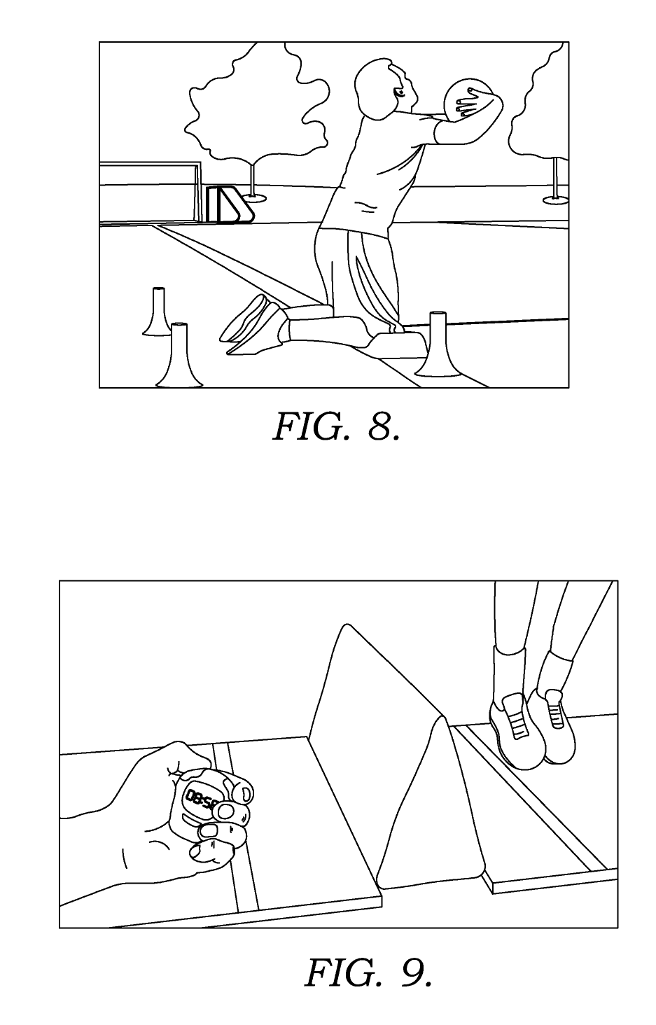

In addition to the foregoing peak power, max touch, three-quarter court sprint, and lane agility, the male athlete may also be required to perform a kneeling power ball toss at step 28 and a multi-stage hurdle at step 30. FIG. 8 provides an example of a test setup that an athlete may use to heave a medicine ball for use in determining the kneeling power ball toss rating. Specifically, the athlete begins the test from a kneeling position and heaves a medicine ball of a predetermined weight. In one configuration, the medicine ball is three kilograms and is generally heaved by the athlete from the kneeling position using two hands. The overall distance of travel of the medicine ball may be recorded on the data collection sheet.

The multi-stage hurdle test is performed by requiring the athlete to jump continuously over a hurdle during a predetermined interval, as shown in FIG. 9. In one configuration, the number of two-footed jumps are recorded while the athlete jumps over a twelve-inch tall hurdle during two intervals of twenty seconds, which may be separated by a single rest interval of ten seconds. The number of two-footed jumps that are landed may be recorded as the multi-stage hurdle rating on the data collection sheet.

While the male athletes may be required to perform the kneeling power ball toss and the multi-stage hurdle and while such data may be useful and probative of the overall athletic ability of the athlete, the data from the kneeling power ball toss and the multi-stage hurdle may not be used in determining the overall athleticism rating.

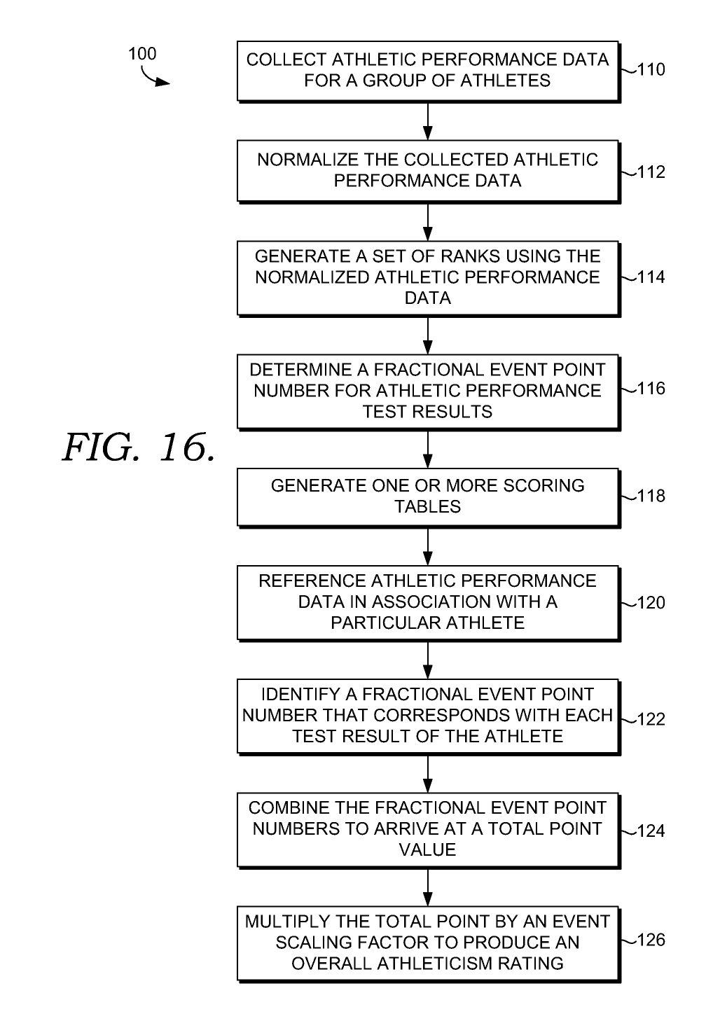

The results from each test for a given athlete are normalized by comparing the test results to a database providing the distribution of test results among a similar class of athletes and then assigning each test result a ranking number based on that test result's percentile among the normal distribution of test results. For example, the peak power, max-touch, three-quarter court sprint, and lane agility data may be referenced in a single table or individual look-up tables corresponding to peak power, max touch, three-quarter court sprint, and lane agility at step 32. The look-up tables may contain point values that are assigned based on the score of the particular test (i.e., peak power, max-touch, three-quarter court sprint, and lane agility). The assigned point values may be recorded at step 34. The point values assigned by the look-up tables may be scaled and combined at step 36 for use in generating an overall athleticism rating at 38. The process is further described with reference to FIG. 16.

With continued reference to FIG. 1, when the determination is made that the subject athlete is a female at step 14, the no-step vertical jump is recorded at step 40. As with the male athlete, the no-step vertical jump test generally reveals an athlete's development of lower-body peak power and is performed on a court or other hard flat, level surface. The athlete performs a counter-movement vertical jump by squatting down and jumping up off two feet while utilizing arm swing to achieve the greatest height (FIG. 4).

Following measurement of the no-step vertical jump, the max touch of the female athlete is measured at 42 and the three-quarter court sprint is measured at step 44. Lane agility is measured at step 46 and is used in conjunction with the no-step vertical jump, max touch, and three-quarter court sprint in determining the overall athleticism rating of the female athlete.

As with the male athlete, the female athlete is subjected to the kneeling power ball toss test at step 48 and the multi-stage hurdle test at step 50. While the test is performed in the same fashion for the female athletes as with the male athletes—as shown in FIG. 8—the female athletes may use a lighter medicine ball. In one configuration, the male athletes use a three kilogram medicine ball while the female athletes use a two kilogram medicine ball.

Once the foregoing tests are performed at steps 40, 42, 44, 46, 48, and 50, the no-step vertical jump, max touch, three-quarter court sprint, lane agility, kneeling power ball toss, and multi-stage hurdle data are referenced on a single look-up table or individual look-up tables at 52.

Referencing the data from each of the respective tests on the look-up tables assigns each test with point values at step 54. The points assigned at step 54 may then be combined and scaled at step 56, whereby an overall athleticism rating may be generated at step 58 based on the scaled and combined points.

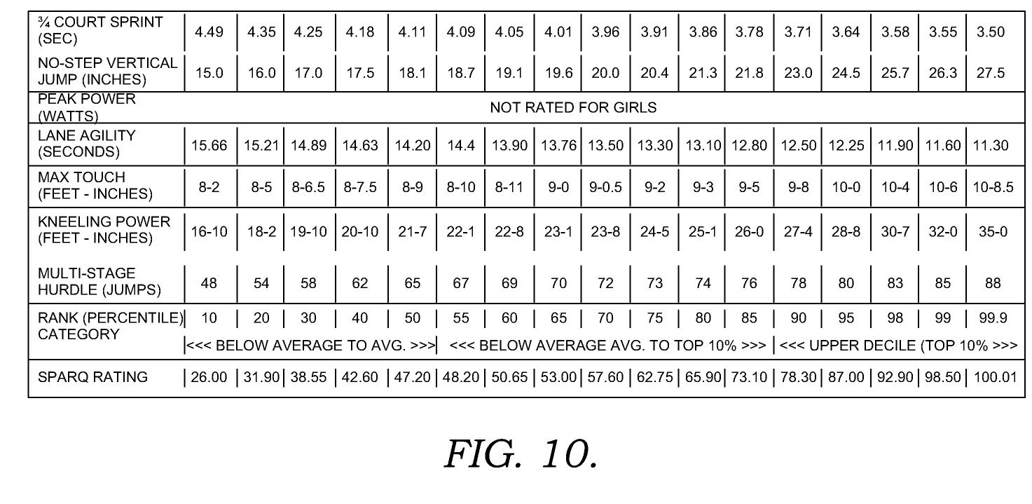

While testing for the female athlete is similar to the male athlete, the weight of the female athlete is not recorded. As such, the peak power may not be used in determining the female athlete's overall athleticism rating. While the peak power may not be used in determining the female athlete's overall athleticism rating, the no-step vertical jump height, kneeling power ball toss, and multi-stage hurdle are referenced and used to determine the overall athleticism rating, as set forth above. An exemplary look-up table is provided at FIG. 10 and provides performance ratings for female athletes for each of a series of tests.

Regardless of the gender of the particular athlete, the look-up tables may be determined by measuring and recording normative test data over hundreds or thousands of athletes. The normative data may be sorted by tests to map the range of performance and establish percentile rankings and thresholds for each test value observed during testing of the athletes. The tabulated rankings may be scored and converted into points using a statistical function to build each scoring look-up table for each particular test (i.e., peak power, max-touch, three-quarter court sprint, and lane agility). Once the look-up tables are constructed, test data may be referenced on the look-up table for determining an overall athleticism rating.

A single athlete's sample test data may be retrieved from the data collection card and may then be ranked, scored, and scaled to yield an overall athleticism rating.

Test data collected in the field at a test event (e.g., combine, camp, etc.) is entered, for example, via a handheld device (not shown) to be recorded in a database and may be displayed on the handheld device or remotely from the handheld device in the format shown in FIG. 2. Two trials may be allowed for each test, except multi-stage hurdle (MSH) which is one trial comprising two jump stages.

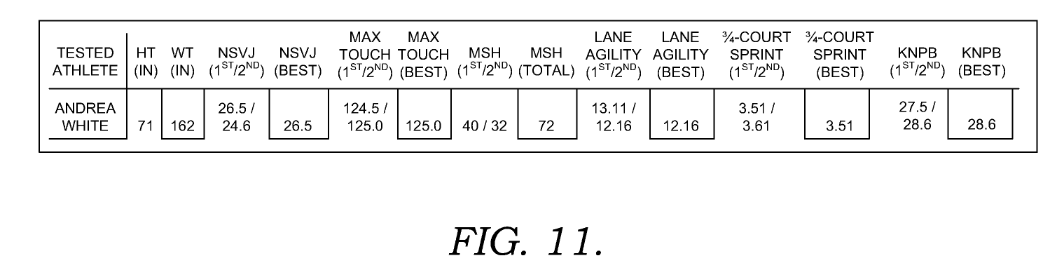

FIG. 11 provides an example of collected data. The tests units for FIG. 11 are as follows: NSVJ=no-step vertical jump (inches); Max Tough (inches); MSH=multi-stage hurdle (number of jumps); Lane Agility (seconds); three-quarter Court sprint (seconds); KnPB=kneeling Power Ball toss (feet).

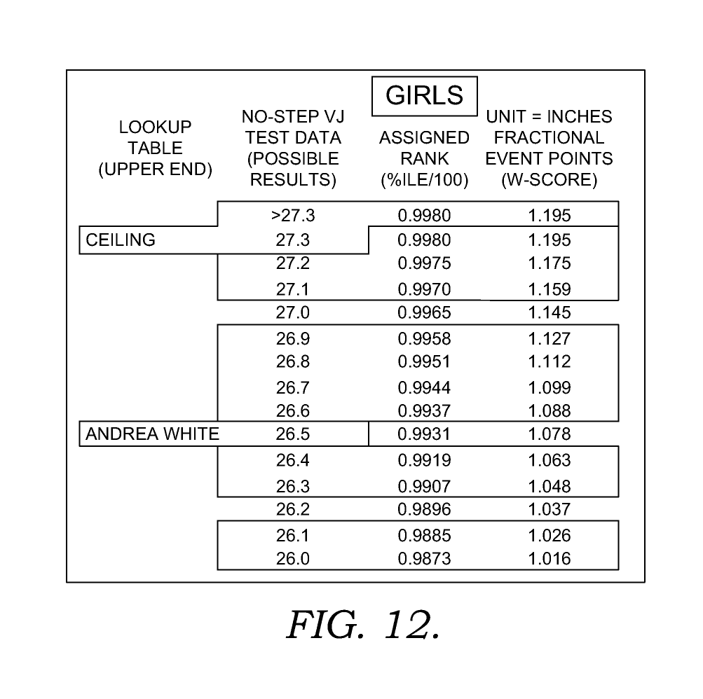

The best result from each test is translated into fractional event points by referencing the test result in the scoring (lookup) table provided for each test. For a male athlete's basketball rating, for example, the no-step vertical jump is a test, but peak power (as derived from body weight and no-step vertical jump height) is the scored event. A look-up table for no-step vertical jump for a female athlete (upper end of performance range) is provided in FIG. 12 to illustrate one example of a look-up table. Each possible test result corresponds to an assigned rank and fractional event points.

In the above example of FIG. 12, the rank assigned to each test result may be derived from normative data previously collected for hundreds of teenage female basketball players at various events around the country. This normative data is sorted and each value transformed into its percentile of the empirical cumulative distribution function (eCDF). This percentile, or rank, depends on the raw test measurements (norm data) and is a function of both the size of the data set and the component test values.

The above athleticism scoring system includes two steps: normalization of raw scores and converting normalized scores to accumulated points. Normalization is a prerequisite for comparing data from different tests. Step 1 ensures that subsequent comparisons are meaningful while step 2 determines the specific facets of the scoring system (e.g., is extreme performance rewarded progressively or are returns diminishing). Because the mapping developed in step 2 converts standardized scores to points, it never requires updating and applies universally to all tests—regardless of sport and measurement scale. Prudent choice of normalization and transformation functions provides a consistent rating to value performance according to predetermined properties.

In order to compare results of different tests comprising the battery, it is necessary to standardize the results on a common scale. If data are normal, a common standardization is the z-score, which represents the (signed) number of standard deviations between the observation and the mean value. However, when data are non-normal, z-scores are no longer appropriate as they do not have consistent interpretation for data from different distributions. A more robust standardization is the percentile of the empirical cumulative distribution function (ECDF), u, defined as follows:

$$u = \frac{1}{n + 1} [ {\sum }_{j} ( 𝕀 \{ {y}_{j} < x \} + \frac{1}{2} 𝕀 \{ {y}_{j} = x \} ) + \frac{1}{2} ] ,$$

In the above equation, x is the raw measurement to be standardized; y₁, y₂, . . . , yₙ are the data used to calibrate the event and II{A} is an indicator function equal to 1 if the event A occurs and 0 otherwise. Note that u depends on both the raw measurement of interest, x, and the raw measurements of peers, y.

The addition of ½ to the summation in square brackets and the use of (n+1) in the denominator ensures that u∈(0, 1) with strict inequality. Although the definition is cumbersome, u is calculated easily by ordering and counting the combined data set consisting of all calibration data (y₁, y₂, . . . , yₙ) and the raw score to be standardized, x.

$$\begin{matrix}u = \frac{[ \# of {y}^{′} s less than x ] + 0.5 [ ( \# of {y}^{′} s equal to x ) + 1 ]}{\# of {y}^{′} s + 1} \\ = \frac{\begin{matrix}[ \# of ( {y}^{′} s and x ) less than x ] + \\ 0.5 [ \# of ( {y}^{′} s and x ) equal to x ]\end{matrix}}{\# of ( {y}^{′} s and x )}\end{matrix}$$

Note that this definition still applies to binned data (though raw data should be used whenever possible).

Although the ECDFs calculated in step 1 provide a common scale by which to compare results from disparate tests, the ECDFs are inappropriate for scoring performance because they do not award points consistently with progressive rewards and percentile “anchors” (sanity checks). Therefore, it is necessary to transform (via a monotonic, 1-to-1 mapping) the computed percentiles into an appropriate point scale.

An inverse-Weibull transformation provides such a transformation and is given by

$$w = {\frac{1}{λ} [ - ln ( 1 - u ) ]}^{1 / α} , where α = 1.610 and λ = 2.512 .$$

The above function relies on two parameters (α and λ) and produces scoring curves that are qualitatively similar to the two-parameter power-law applied to raw scores. The parameters α and λ were chosen to satisfy approximately the following four rules governing the relationship between percentile of performance and points awarded:

1. The 10th percentile should achieve roughly ten percent of the nominal maximum.

2. The 50th percentile should achieve roughly thirty percent of the nominal maximum.

3. The 97.7th percentile should achieve roughly one hundred percent of the nominal maximum.

4. The 99.9th percentile should achieve roughly one hundred twenty-five percent of the nominal maximum.

Because, in general, four constraints cannot be satisfied simultaneously by a two-parameter model, parameters were chosen to minimize some measure of discrepancy (in this case the sum of squared log-errors). However, estimation was relatively insensitive to the specific choice of discrepancy metric.

To illustrate the method when raw (unbinned) data is available, consider scoring three performances, 12, 16, and 30, using a calibration data set consisting of nine observations: 16 20 25 27 19 18 26 27 15.

For x=16, there is one observation in the calibration data (15) that is less than x and one that is equal. Therefore,

$$u = \frac{1}{9 + 1} [ {\sum }_{j} ( 𝕀 \{ {y}_{j} < 16 \} + \frac{1}{2} 𝕀 \{ {y}_{j} = 16 \} ) + \frac{1}{2} ] = \frac{1}{10} [ 1 + \frac{1}{2} + \frac{1}{2} ] = 0.20 .$$

A summary of calculations is given in the following table.

| x | Σⱼ [symbol] {yⱼ < x} | Σⱼ [symbol] {yⱼ = x} | u | w |
|---|---|---|---|---|
| 12 | 0 | 0 | [0 + (0.5)(0) + 0.5]/(9 + 1) = | 0.063 |
| | | | 0.05 | |
| 16 | 1 | 1 | [1 + (0.5)(1) + 0.5]/(9 + 1) = | 0.157 |
| | | | 0.20 | |
| 30 | 9 | 0 | [9 + (0.5)(0) + 0.5]/(9 + 1) = | 0.787 |
| | | | 0.95 | |

For backward compatibility, it may be necessary to score athletes based on binned data. Consider scoring four performances, 40, 120, 135, and 180, using a calibration data set binned as follows. Here, the bin label corresponds to the lower bound, e.g., the bin labeled 90 contains measurements from the interval (90, 100).

| Bin | Count |
|---|---|
| <50 | 0 |
| 50 | 2 |
| 60 | 19 |
| 70 | 33 |
| 80 | 63 |
| 90 | 39 |
| 100 | 20 |
| 110 | 17 |
| 120 | 26 |
| 130 | 14 |
| 140 | 4 |
| 150 | 3 |
| 160 | 1 |
| 170 | 4 |
| Total | 245 |

For x=135, there are 0+2+ . . . +17+26=219 observations that are in bins less than the one that contains x and 14 that fall in the same bin. Therefore,

$$\begin{matrix}u = \frac{1}{245 + 1} [ {\sum }_{j} ( \begin{matrix}𝕀 \{ {y}_{j} < bin containing 135 \} + \frac{1}{2} \\ 𝕀 \{ {y}_{j} in bin containing 135 \} + \frac{1}{2}\end{matrix} ) ] \\ = \frac{1}{246} [ 219 + 7 + \frac{1}{2} ] \\ = 0.921 .\end{matrix}$$

A summary of calculations is given in the following table.

| x | Σⱼ [symbol] {yⱼ < x} | Σⱼ [symbol] {yⱼ = x} | u | w |
|---|---|---|---|---|
| 40 | 0 | 0 | 0.002 | 0.008 |
| 120 | 193 | 26 | 0.839 | 0.579 |
| 135 | 219 | 14 | 0.921 | 0.709 |
| 180 | 241 | 4 | 0.990 | 1.026 |

The standardization and transformation processes are performed exactly as in the raw data example; however, care must be taken to ensure consistent treatment of bins. All raw values contained in the same bin will result in the same standardized value and thus the same score. In short, scoring based on binned data simplifies data collection and storage at the expense of resolution (only a range, not a precise value, is recorded) and complexity (consistent treatment of bin labels).

In rare circumstances, only summary statistics (such as the mean and standard deviation) of the calibration data are available. If an assumption of normal data is made, then raw data can be standardized in Microsoft® Excel® using the normsdist ( ) function.

The above method relies heavily on the assumption of normality. Therefore if data are not normal it will, naturally, perform poorly. Due to the assumed normality, this method does not enjoy the robustness of the ECDF method based on raw or binned data and should be avoided unless there is no other alternative.

To illustrate this technique, assume that the mean and standard deviation of a normally distributed calibration data set are 98.48 and 24.71, respectively, and it is desirable to score x=150. In this case, u=normsdist((150-98.48)/24.71)=0.981.

As before,

$$w = {\frac{1}{λ} [ - ln ( 1 - u ) ]}^{1 / α} = {\frac{1}{2.512} [ - ln ( 1 - 0.981 ) ]}^{1 / 1.610} = 0.924 .$$

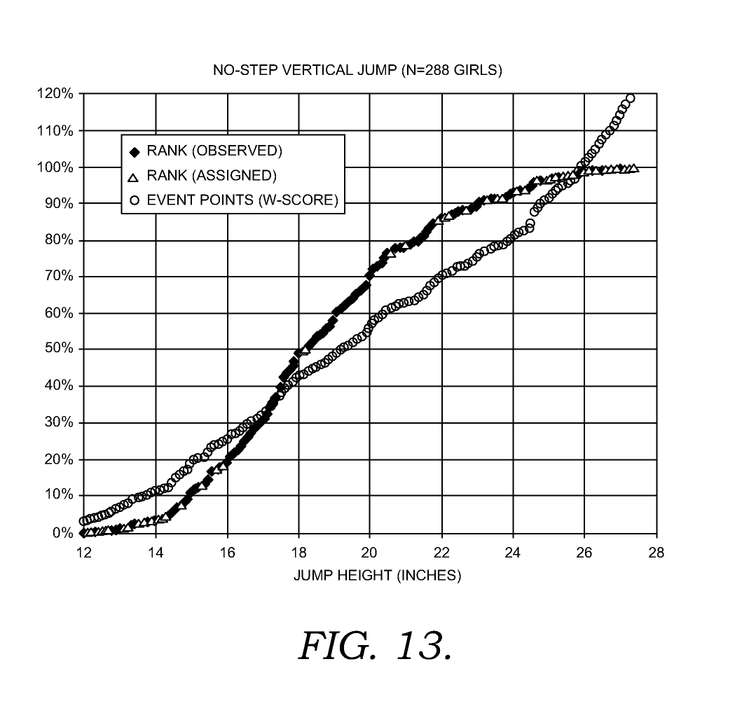

Once the norm data has been collected and sorted in a manner, as set forth above for a given test, its eCDF is scatter plotted to reveal the Performance Curve. For example, non-standing vertical jump data observed in the field for 288 girls are shown as indicated in FIG. 13. For those results not observed, e.g., 26.6 inches, that value's rank (99.37 percentile) is assigned by interpolation; the unobserved points requiring assigned ranks are shown as indicated in FIG. 13.

For each test, a “ceiling” and a “floor” value is determined, which represent the boundaries of scoring for each test. Any test value at or above the ceiling earns the same number of event points. Likewise, any test value at or below the floor earns the same number of event points. These boundaries serve to keep the rating scale intact. The ceiling limits the chance of a single exceptional test result skewing an athlete's rating, thereby masking mediocre performance in other tests.

Each rank is transformed to fractional event points using a statistical function, as set forth above with respect to the Inverse Weibull Transformation. The scoring curve of event points is shown for girls' no-step vertical jump in FIG. 13, as indicated therein, where the points are displayed as percentages, i.e., 0.50 points (awarded for a jump of 18.1 inches) are shown as fifty percent. These fractional event points are also referred to as the w-score (“w” for Weibull).

The Inverse Weibull Transformation can process non-normal (skewed) distributions of test data, as described above. The transformation also allows for progressive scoring at the upper end of the performance range. Progressive scoring assigns points progressively (more generously) for test results that are more exceptional. This progression is illustrated in FIG. 13 for jumps higher than 26 inches, where the red curve gets progressively steep and the individual data points more distinct. Progressive scoring allows for accentuation of elite performance, thus making the rating more useful as a tool for talent identification.

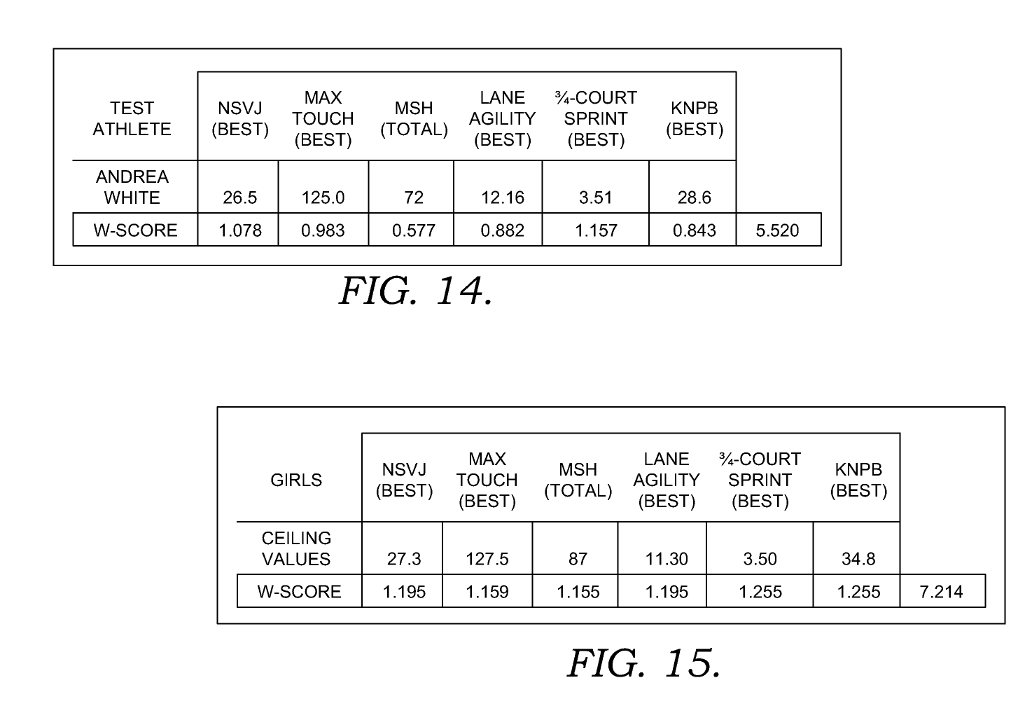

FIG. 12 identifies a sample athlete, “Andrea White” who jumped 26.5 inches during a no-step vertical jump. This value corresponds to w-score of 1.078. The w-scores for all of her tests are found by referencing those tests' respective look-up tables. These w-scores are shown in FIG. 14.

The fractional event points are summed for each ratings test variable to arrive at the athlete's total w-score (5.520 in FIG. 14, for example). This total is multiplied by an event scaling factor to produce a rating. For a girls' basketball rating, for example, this scaling factor is 18, and so Andrea White's overall athleticism Rating is 99.36 (=5.520×18). The “event scaling factor” is determined for each rating by the number of rated events and desired rating range. Ratings should generally fall within a range of 10 to 110. A boys' scaling factor is 25, for example, as the rating comprises four variables: Peak Power, Max Touch, Lane Agility, and three-quarter Court Sprint.

Were a female athlete to “hit the ceiling” on all six tests (shown in FIG. 15), her w-score total would yield a rating of almost 130 (129.85).

Regardless of the gender of the particular athlete, Table 1 outlines an exemplary test order for each of the above tests and assigns a time period in which each test should be run.

TABLE 1
Exemplary Test Order and Assigned Time

| Test/Measurement | Time Period |
|---|---|
| Height (without shoes) | N/A |
| Weight | N/A |
| No-Step Vertical Jump | Less than one (1) minute |
| Max Touch | One (1) minute |
| Three Quarter (¾) Court Sprint | Less than one (1) minute |
| Lane Agility | One (1) to one and a half (1.5) minutes |
| Kneeling Power Ball Toss | One (1) to one and a half (1.5) minutes |
| Multi-Stage Hurdle | One (1) minute |

Assessing each of the various scores for each test provides the athlete with an overall athleticism rating, which may be used by the athlete in comparing their ability and/or performance to other athletes within their age group. Furthermore, the athlete may use such information to compare their skill set with those of NBA or WNBA players to determine how their skill set compares with that of a professional basketball player.

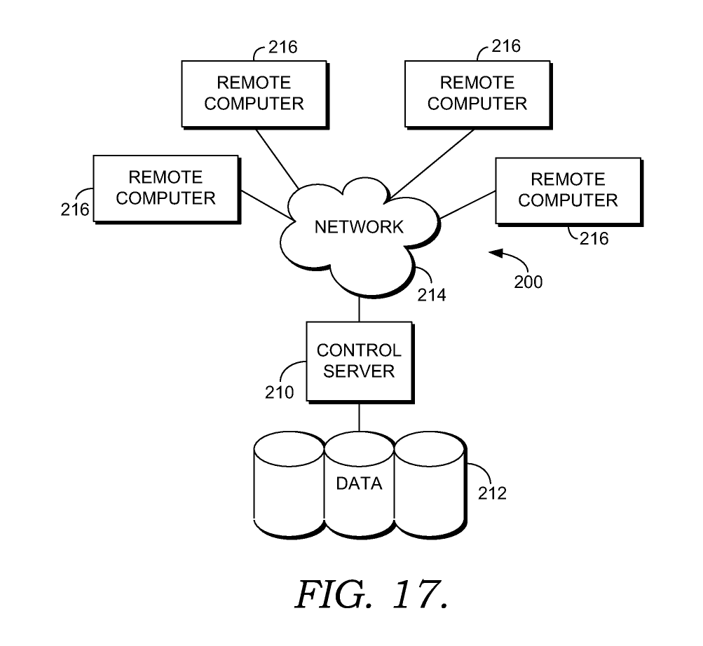

With reference to FIG. 16, in accordance with an embodiment of the present invention, an exemplary method 100 for generating an athleticism rating score is illustrated. An athleticism rating score can be generated for a particular athlete in association with a defined sport, such as basketball. Such an athleticism rating score can then be used, for example, to recognize athleticism of an individual and/or to compare athletes. Initially, as indicated at step 110, athletic performance data related to a particular sport is collected for a group of athletes. Athletic performance data might include, by way of example, and not limitation, a no-step vertical jump height, an approach jump reach height, a sprint time for a predetermined distance, a cycle time around a predetermined course, or the like. Athletic performance data can be recorded for a group of hundreds or thousands of athletes. Such athletic performance data can be stored in a data store, such as database 212 of FIG. 17.

At step 112, the collected athletic performance data, such as athletic performance test results, are normalized. Accordingly, athletic performance test results (e.g., raw test results) for each athletic test performed by an athlete in association with a defined sport are normalized. That is, raw test results for each athlete can be standardized in accordance with a common scale. Normalization enables a comparison of data corresponding with different athletic tests. In one embodiment, a normalized athletic performance datum is a percentile of the empirical cumulative distribution function (ECDF). As one skilled in the art will appreciate, any method can be utilized to obtain normalized athletic performance data (i.e., athletic performance data that has been normalized).

At step 114, the normalized athletic performance data is utilized to generate a set of ranks. The set of ranks includes an assigned rank for each athletic performance test result included within a scoring table. A scoring table (e.g., a lookup table) includes a set of athletic performance test results, or possibilities thereof. Each athletic performance test result within a scoring table corresponds with an assigned rank and/or a fractional event point number. In one embodiment, the athletic performance data is sorted and a percentile of the empirical cumulative distribution function (ECDF) is calculated for each value. As such, the percentile of the empirical cumulative distribution function represents a rank for a specific athletic performance test result included in the scoring table. In this regard, each athletic performance test result is assigned a ranking number based on that test result's percentile among the normal distribution of test results. The rank (e.g., percentile) depends on the raw test measurements and is a function of both the size of the data set and the component test values. As can be appreciated, a scoring table might include observed athletic performance test results and unobserved athletic performance test results. A rank that corresponds with an unobserved athletic performance test result can be assigned using interpolation of the observed athletic performance test data.

At step 116, a fractional event point number is determined for each athletic performance test result. A fractional event point number for a particular athletic performance test result is determined or calculated based on the corresponding assigned rank. That is, the set of assigned ranks, or percentiles, is transformed into an appropriate point scale. In one embodiment, a statistical function, such as an inverse-Weibull transformation, provides such a transformation.

At step 118, one or more scoring tables are generated. As previously mentioned, a scoring table (e.g., a lookup table) includes a set of athletic performance test results, or possibilities thereof. Each athletic performance test result within a scoring table corresponds with an assigned rank and/or a fractional event point number. In some cases, a single scoring table that includes data associated with multiple tests and/or sports can be generated. Alternatively, multiple scoring tables can be generated. For instance, a scoring table might be generated for each sport or for each athletic performance test. One or more scoring tables, or a portion thereof (e.g., athletic test results, assigned ranks, fractional event point numbers, etc.) can be stored in a data store, such as database 212 of FIG. 17.

As indicated at step 120, athletic performance data in association with a particular athlete is referenced (e.g., received, obtained, retrieved, identified, or the like). That is, athletic performance test results for a plurality of different athletic performance tests are referenced. The set of athletic tests can be predefined in accordance with a particular sport or other physical activity. An athletic performance test is designed to assess the athletic ability and/or performance of a given athlete and measures an athletic performance skill related to a particular sport or physical activity.

The referenced athletic performance data can be measured and collected in the field at a test event. Such data can be entered via a handheld device (e.g., remote computer 216 of FIG. 17) or other computing device (e.g., control server 210 of FIG. 17) to be recorded in a database (e.g., database 212 of FIG. 17). As such, the data can be stored within a data store of the device that receives the input (e.g., remote computer 216 or control server 210 of FIG. 17). Alternatively, the data can be stored within a data store remote from the device that receives the input. In such a case, the device receiving the data input communicates the data to the remote data store or computing device in association therewith. By way of example only, an evaluator can enter athletic performance data, such as athletic performance test results, into a handheld device. Upon entering the data into the handheld device, the data can be transmitted to a control server (e.g., control server 210 of FIG. 17) for storage in a data store (e.g., database 212 of FIG. 17). The collected data may be displayed on the handheld device or remotely from the handheld device.

At step 122, a fractional event point number that corresponds with each test result of the athlete is identified. Using a scoring table, a fractional event point number can be looked up or recognized based on the athletic performance test result for the athlete. In embodiments, the best result from each test is translated into a fractional event point number by referencing the test result in the lookup table for each test. Although method 100 generally describes generating a scoring table having a rank and a fractional event point number that corresponds with each test result to use to lookup a fractional event point number for a specific athletic performance test result, alternative methods can be utilized to identify or determine a fractional event point number for a test result. For instance, in some cases, upon receiving an athlete's test results, a rank and/or a fractional event point number could be determined. In this regard, an algorithm can be performed in real time to calculate a fractional event point number for a specific athletic performance test result. By way of example only, an athletic performance test result for a particular athlete can be compared to a distribution of test results of athletic data for athletes similar to the athlete, and a percentile ranking for the test result can be determined. Thereafter, the percentile ranking for the test result can be transformed to a fractional event point number.

At step 124, the fractional event point number for each relevant test result for the athlete is combined or aggregated to arrive at a total point score. That is, the fractional event point number for each test result for the athlete is summed to calculate the athlete's total point score. At step 126, the total point score is multiplied by an event scaling factor to produce an overall athleticism rating. An event scaling factor can be determined using the number of rated events and/or desired rating range. Athletic data associated with a particular athlete, such as athletic test results, ranks, fractional event point numbers, total point values, overall athleticism rating, or the like, can be stored in a data store, such as database 212 of FIG. 17.

Having briefly described embodiments of the present invention, an exemplary operating environment suitable for use in implementing embodiments of the present invention is described below.

Referring to FIG. 17, an exemplary computing system environment, an athletic performance information computing system environment, with which embodiments of the present invention may be implemented is illustrated and designated generally as reference numeral 200. It will be understood and appreciated by those of ordinary skill in the art that the illustrated athletic performance information computing system environment 200 is merely an example of one suitable computing environment and is not intended to suggest any limitation as to the scope of use or functionality of the invention. Neither should the athletic performance information computing system environment 200 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in association with local and/or remote computer storage media including, by way of example only, memory storage devices.

With continued reference to FIG. 17, the exemplary athletic performance information computing system environment 200 includes a general purpose computing device in the form of a control server 210. Components of the control server 210 may include, without limitation, a processing unit, internal system memory, and a suitable system bus for coupling various system components, including database cluster 212, with the control server 210. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 210 typically includes therein, or has access to, a variety of computer-readable media, for instance, database cluster 212. Computer-readable media can be any available media that may be accessed by server 210, and includes volatile and nonvolatile media, as well as removable and non-removable media. By way of example, and not limitation, computer-readable media may include computer storage media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 210. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 17, including database cluster 212, provide storage of computer-readable instructions, data structures, program modules, and other data for the control server 210. The control server 210 may operate in a computer network 214 using logical connections to one or more remote computers 216. Remote computers 216 may be located at a variety of locations in an athletic training or performance environment. The remote computers 216 may be handheld computing devices, personal computers, servers, routers, network PCs, peer devices, other common network nodes, or the like, and may include some or all of the elements described above in relation to the control server 210. The devices can be personal digital assistants or other like devices.

Exemplary computer networks 214 may include, without limitation, local area networks (LANs) and/or wide area networks (WANs). Such networking environments are commonplace in offices, enterprise-wide computer networks, intranets, and the Internet. When utilized in a WAN networking environment, the control server 210 may include a modem or other means for establishing communications over the WAN, such as the Internet. In a networked environment, program modules or portions thereof may be stored in association with the control server 210, the database cluster 212, or any of the remote computers 216. For example, and not by way of limitation, various application programs may reside on the memory associated with any one or more of the remote computers 216. It will be appreciated by those of ordinary skill in the art that the network connections shown are exemplary and other means of establishing a communications link between the computers (e.g., control server 210 and remote computers 216) may be utilized.

In operation, an athletic performance evaluator (e.g., a coach, recruiter, etc.), may enter commands and information into the control server 210 or convey the commands and information to the control server 210 via one or more of the remote computers 216 through input devices, such as a keyboard, a pointing device (commonly referred to as a mouse), a trackball, or a touch pad. Other input devices may include, without limitation, microphones, satellite dishes, scanners, or the like. Commands and information may also be sent directly from an athletic performance device to the control server 210. In addition to a monitor, the control server 210 and/or remote computers 216 may include other peripheral output devices, such as speakers and a printer.

Although many other internal components of the control server 210 and the remote computers 216 are not shown, those of ordinary skill in the art will appreciate that such components and their interconnection are well known. Accordingly, additional details concerning the internal construction of the control server 210 and the remote computers 216 are not further disclosed herein.

In other embodiments, different tests may be administered to determine an athlete's athleticism for a different sport. For example, in the sport of fastpitch softball, the method may involve testing athletes in four discrete tests that may be used to determine a female's overall athleticism for this sport. Specifically, the athletic performance tests may include measuring vertical jump of an athlete, measuring total time to complete an agility shuttle, measuring sprint time of the athlete over a 20-yard distance and measuring the distance of a rotational power ball throw.

The vertical jump is a standing a no-step vertical jump similar to the jump described above. The 20-yard dash is timed sprint.

The agility shuttle is a 5-10-5 agility test. Three cones (lines or other obstacles) are placed in a line at distances of five yards from one another. The athlete begins at the center cone while touching the cone with one hand. The athlete is not allowed to face or lean toward either of the outside cones at the start. Upon movement, the athlete sprints to the outside cone opposite the hand initially touching the cone. The athlete touches this outside cone, reverses directions and sprints to the other outside cone. Once this cone is touched, the athlete changes directions again and sprints past the center cone. The measured time begins when the athlete removes her hand from the center cone and ends when the athlete runs past the center cone.

The rotational power ball throw may be conducted with a three kilogram power ball. The athlete begins by standing perpendicular to a start line similar to a hitting stance in softball. The athlete may step on or touch the starting line but may not step over the line. The ball is cradled in two hands with the athlete's backhand (palm facing the start line) on the back of the ball and the front hand under the ball. The ball is drawn back while maintaining the ball between the athlete's waist and chest. The athletes arms should be fully extended with only a slight bend in the elbow. In one motion, the athlete rotates her body to sing the ball forward, optimally, at a forty-five degree angle. The motion simulates the swing of a bat in softball. The athlete finishes with her arms extended. The athlete may follow through but her feet shall not extend beyond the line until the ball is released. The distance the ball travels is measured.

The athletic data are captured similarly to the methods for collecting basketball testing data. For example, the data may be entered into a handheld computing device. Two trials may be allowed for each test, and the best result used to formulate the rating as set forth below.

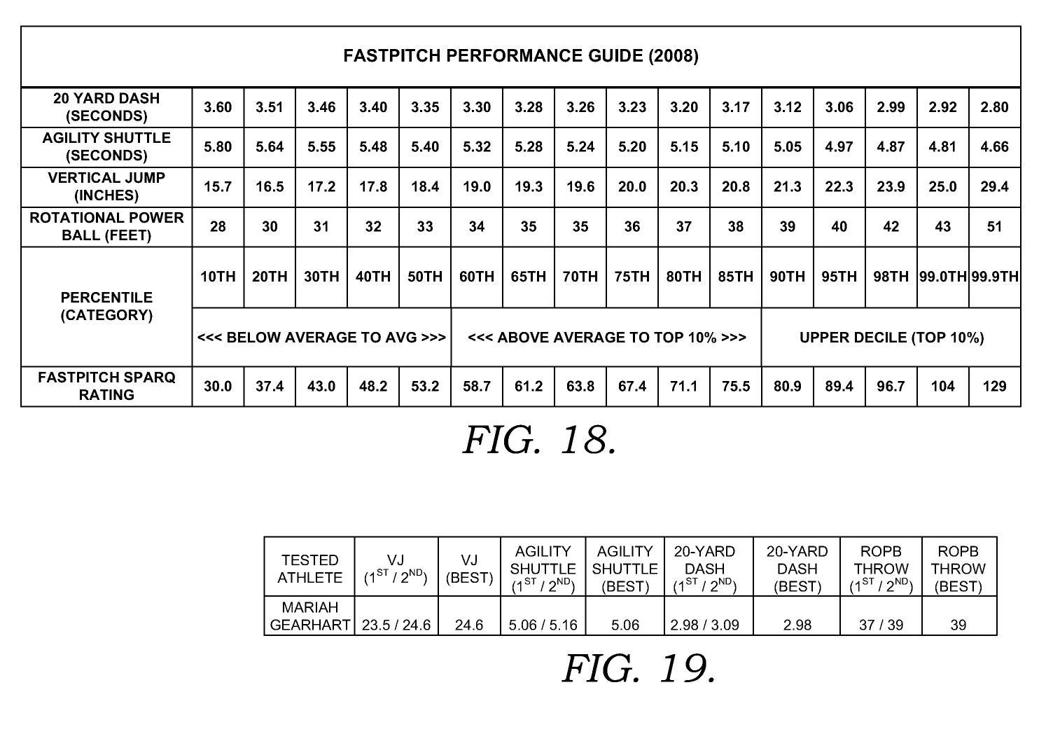

The best result from each test is translated into fractional event points by referencing the test result in the scoring (lookup) table. An exemplary look-up table is provided at FIG. 18 and provides a performance rating for a female athlete for each of a series of tests. Similar to the table (FIG. 10) for basketball, the loop-up table may be determined by measuring and recording normative test data over hundreds or thousands of athletes, and sorted by tests to map the range of performance and establish percentile rankings and thresholds for each test value observed during testing of the athletes. Also, as described above, the tabulated rankings may be scored and converted into points using a statistical function to build each scoring look-up table for each particular test (i.e., vertical jump, agility shuttle, 20-yard dash and rotational power ball throw).

FIG. 19 provides an example of collected data. The test units for FIG. 19 are as follows: VJ=vertical jump (inches); Agility Shuttle (seconds); 20-yard Dash (seconds); RoPB Throw (feet). First, the best result from each test is translated into fractional event points by referencing the scoring (lookup) table.

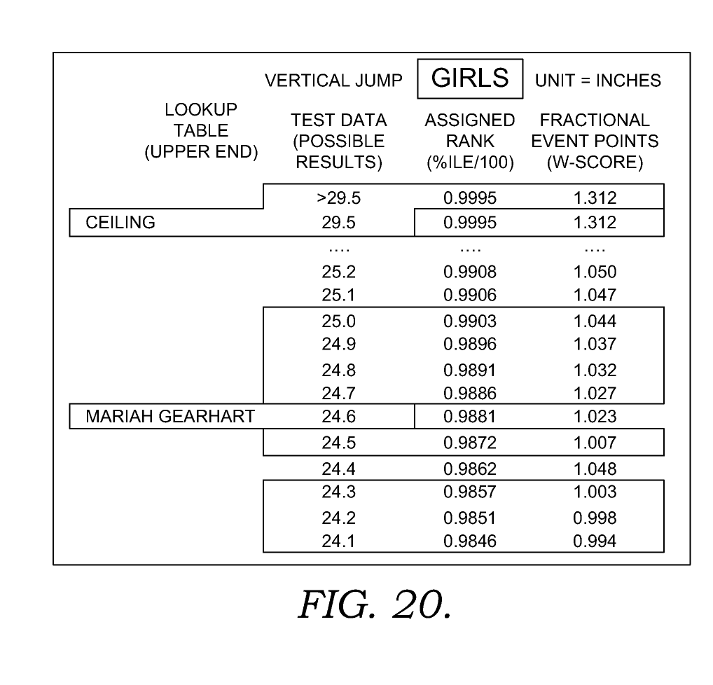

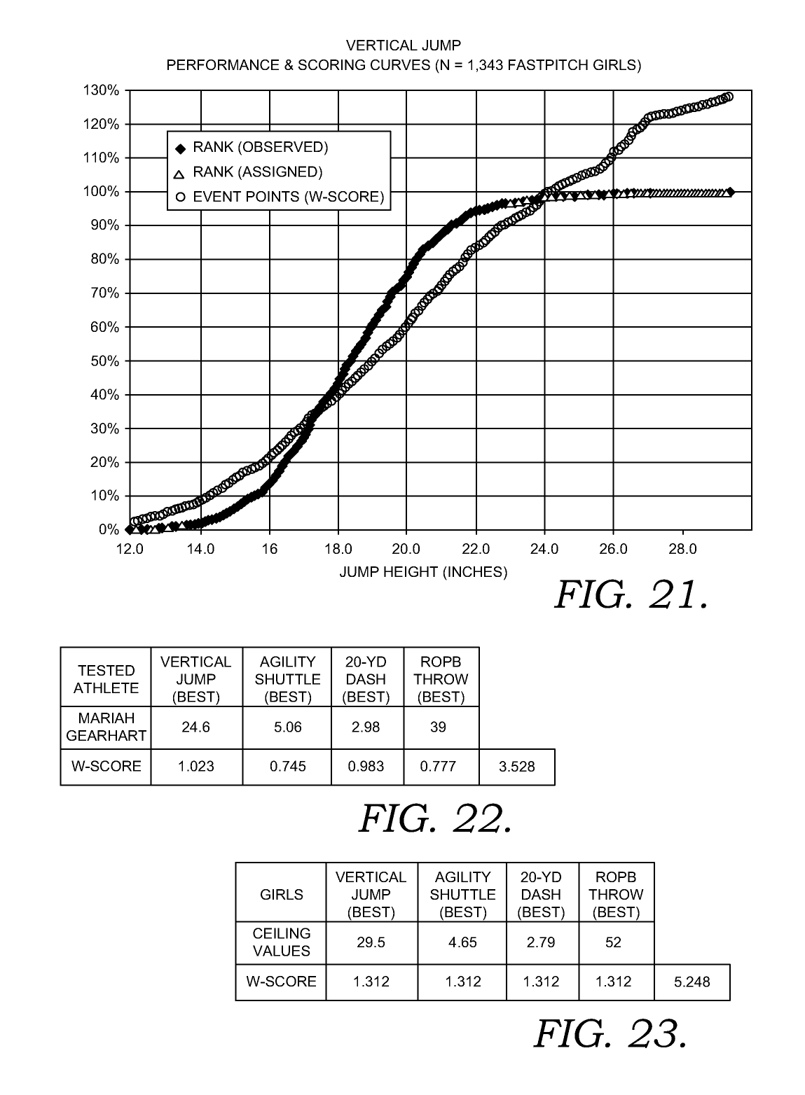

As described fully above with reference to FIG. 12, in FIG. 20, the rank assigned to each test may be derived from normative data that are sorted and transformed into its percentile of the eCDF function. Once the norm data has been collected and sorted as described in detail above, its eCDF is scatter plotted to reveal a performance curve. For example, vertical jump data observed in the field observed for 1343 girls are shown in the curve of FIG. 21 as blue diamonds. For those results not observed, that value's rank is assigned by interpolation; the unobserved points requiring assigned ranks are show as yellow triangles in FIG. 21. Ceiling and floor values are established as set forth above.

As also described above, each rank is transformed to fractional event points using a statistical function, i.e., the Inverse Weibull Transformation. The scoring curve of event points for the vertical jump is shown in red circles on FIG. 21, where the points are displayed as percentages, i.e., 0.50 points awards for 61^{st} percentile jump of 19.1 inches shown as 50% for girls fastpitch softball. Again, the fractional points are the w-score. Similar to the curves for basketball, the Inverse Weibull Transformation can process non-normal (skewed) distributions of test data, and allows for progressive scoring to accentuate elite performance as demonstrated by the steepness of the w-score curve between 26 inches and 27 inches.

With reference to FIG. 19, a sample athlete “Mariah Gearhart” jumped 24.6 inches during a no-step vertical jump. This value corresponds to w-score of 1.023 (FIG. 20). The w-scores for all of her tests are found by referencing those tests' respective look-up tables. These w-scores are shown in FIG. 22.

To achieve scaling, the fractional event points are summed for each rating test variable to arrive at the athlete's total w-score 3.528 as illustrated in FIG. 22, for sample athlete Mariah Gearhart. This total is multiplied by an event scaling factor to produce a rating. For a girls' fastpitch rating, for example, this scaling factor is 30, and so Mariah Gearhart's overall athleticism Rating is 105.84 (= or 3.528×30).

The “event scaling factor” is determined for each rating by the number of rated events and desired rating range. Ratings should generally fall within a range of 10 to 110. Were a female athlete to “hit the ceiling” on all four tests (shown in FIG. 23), her w-score total would yield a rating of 157.44 (or 5.248×30). In an embodiment, a ceiling (i.e., 120) may be imposed to limit the overall score for extreme outliers.

In another embodiment, different tests may be administered to determine an athlete's athleticism for football. Specifically, the athletic performance tests may include measuring vertical jump of an athlete, measuring total time to complete an agility shuttle, a kneeling powerball toss, measuring sprint time of the athlete over a 40-yard distance and a peak power-vertical jump. The agility shuttle is described above, and 40-yard dash is similar to the 20-yard dash described above. The kneeling powerball toss is performed by heaving a 3 kg power ball from the chest while in a kneeling position. The movement resembles a two-handed chest pass in basketball except while kneeling and with a prescribed ball trajectory of 30-40 degrees above level for the greatest distance. The power-vertical jump gauges lower body peak power and incorporates weight in combination with vertical. In embodiments, a contact mat is utilized to determine the vertical height of the jump. The power-vertical testing may incorporate weight for the initial event result in a number of manners. In other embodiments, vertical jump alone may be used. In an example of power-vertical testing incorporating weight, the event result for peak power may use the following equation:

PeakPower(watts)=[60.7×VerticalJump(cm)]+[45.3×Weight(kg)]−2055

In the football embodiment, the results are processed using the system and methods discussed above.

The present invention has been described in relation to particular embodiments, which are intended in all respects to be illustrative rather than restrictive. Alternative embodiments will become apparent to those of ordinary skill in the art to which the present invention pertains without departing from its scope.

In another embodiment, different tests may be administered to determine an athlete's athleticism for soccer (or global football). Specifically, the athletic performance tests may include measuring peak power vertical jump of an athlete, measuring total time to complete an agility shuttle initiated in one direction (i.e., left), measuring total time to complete an arrowhead agility test initiated in the opposite direction (i.e., right), measuring sprint time of the athlete over a 20-meter distance, and Yo Yo Intermittent Recovery Test (YIRT). Two trials of each test are conducted except for the YIRT.

As described above, the power-vertical jump gauges lower body peak power and incorporates weight in combination with vertical leap. In embodiments, a contact mat is utilized to determine the vertical height of the jump. The power-vertical testing may incorporate weight for the initial event result in a number of manners. In other embodiments, vertical jump alone may be used. In an example of power-vertical testing incorporating weight, the event result for peak power may use the following equation:

PeakPower(watts)=[60.7×VerticalJump(cm)]+[45.3×Weight(kg)]−2055

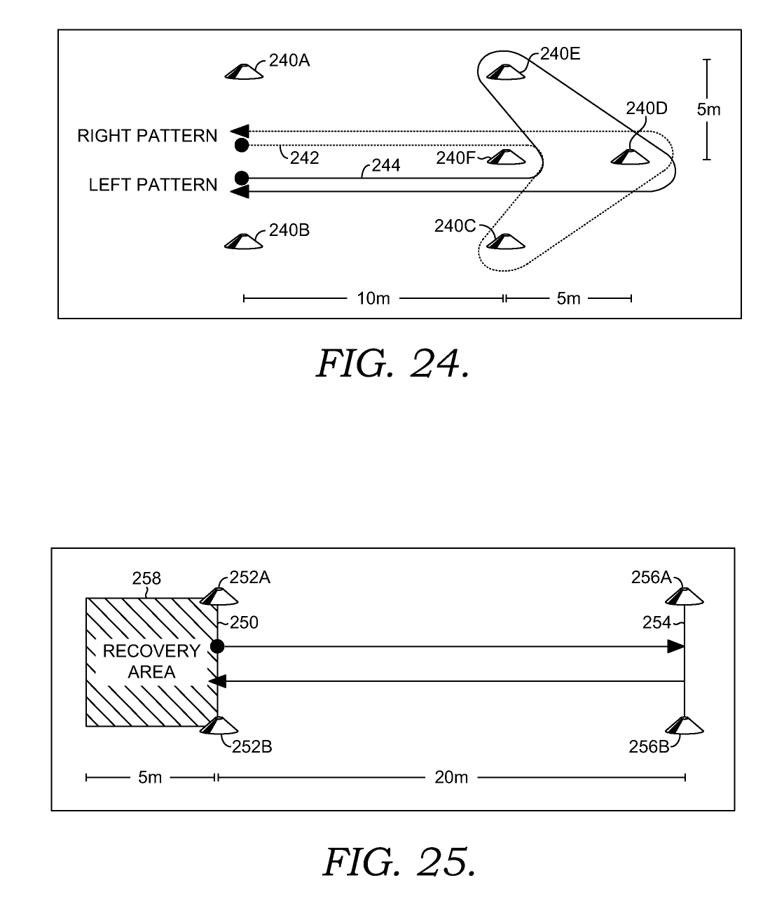

The arrowhead agility test measures the ability to change direction, control posture and agility. With reference to FIG. 24, a number of cones 240A-F are arranged in formation such that cones 240A and 240E, and 240B and 240C, respectively, are ten meters from one another. Cone 240F is centered between cones 240C and 240E in one direction, and cone 240D is positioned perpendicular from the line formed by Cones 240C, 240F and 240E, at a distance five meters from 240F. The athlete is timed over the right pattern designated by dashed line 242, and then rests for at least two or three minutes. Next, the athlete is timed over the left pattern designated by solid line 244. After resting for at least two or three minutes, the athlete repeats the process. Also, in one embodiment, the best results of the arrowhead drill initiated on the “left” path and arrowhead drill initiated on the “right” path are summed before being processed.

The 20-meter dash is described above.

In the Yo Yo Intermittent Recovery Test (YIRT) measures the “start-stop-recover-start” nature of soccer. With reference to FIG. 25, the athletes starts at a starting line 250 located between a pair of cones 252A and 252B, and completes pairs of 20-meter sprints to an intermediate line 254 positioned between a pair of cones 256A and 256B, at a distance of 20-meters from the starting line 250, until failure of the athlete. From a recorded CD, a first beep initiates the first 20-meter sprint, the second beep ends the first 20-meter sprint and initiates the second 20-meter sprint, and the third beep ends the second 20-meter sprint and initiates a ten second recovery period in which the athlete jogs in a recovery zone 258. The athlete is allowed to miss one beep but the second missed beat ends the test. The test typically lasts for three to ten minutes.

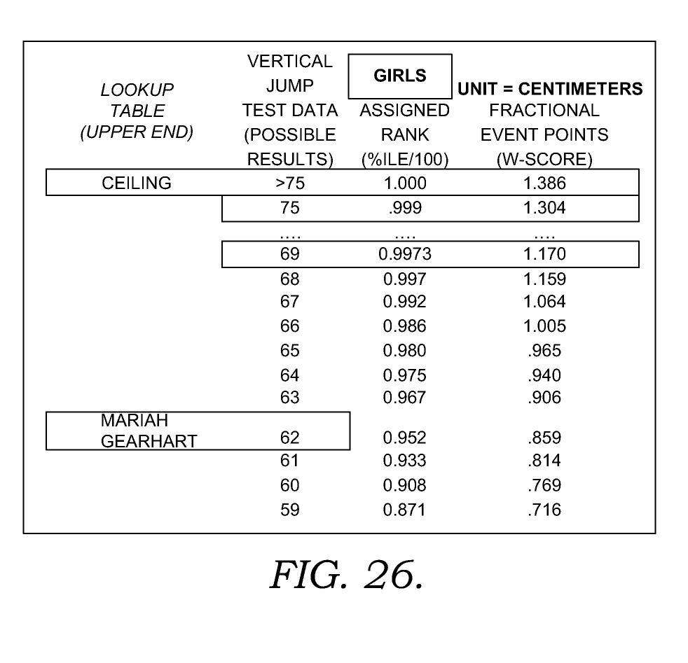

In embodiments, the systems and methods process the event results as described above in the examples for basketball and football. An example of a results table for the verticle jump drill for soccer is provided at FIG. 26. As set forth in this table, the units are in centimeters to reflect the global nature of the game. Similar to the descriptions above, event ratings are multiplied by 25 to calculate the ratings. Also, floor and ceiling values may be applied to preserve scaling.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

What is claimed is:

1. One or more computer-storage media having computer-executable instructions embodied thereon for performing a method in a computing environment for evaluating the athleticism of an athlete in soccer, the method comprising: receiving at least two results for the athlete's performance in at least two different athletic performance tests related to the soccer; comparing each of the at least two results to a corresponding distribution of test results of athletic data for athletes similar to the athlete and determining a percentile ranking for each of the at least two results; transforming the percentile ranking for each of the at least two results to a fractional event point number for each result; and
combining the fractional event point numbers and using a scaling factor to produce an athleticism rating score for the athlete in soccer.

2. The one or more computer-storage media of claim 1, wherein the percentile rankings for each of the at least two results are progressive.

3. The one or more computer-storage media of claim 2, wherein transforming the percentile ranking for the at least two results to the fractional event point number comprises applying an inverse-Weibull transformation.

4. The one or more computer-storage media of claim 1, wherein the distribution of test results of athletic data for athletes similar to the athlete is determined using the empirical cumulative distribution function.

5. The one or more computer-storage media of claim 1, wherein the percentile ranking for each of the at least two results is capped at a ceiling value.

6. The one or more computer-storage media of claim 1, wherein the percentile ranking for each of at least two results is capped at a floor value.

7. The one or more computer-storage media of claim 1, wherein the at least two athletic performance tests include a vertical jump test, a recovery test, a sprint time test, and an agility time test.

8. The one or more computer-storage media of claim 7, wherein the recovery test is a Yo Yo Intermittent Recovery Test.

9. The one or more computer-storage media of claim 8, wherein the sprint time test is a twenty meter sprint.

10. The one or more computer-storage media of claim 8, wherein the vertical jump test is a peak power vertical jump test.

11. The one or more computer-storage media of claim 10, wherein the agility test is an arrowhead agility test.

12. The one or more computer-storage media of claim 1, wherein test results of athletic data for athletes similar to the athlete comprise data from athletes of the same gender as the athlete.

13. The one or more computer-storage media of claim 8, wherein the test results of athletic data for athletes similar to the athlete comprise data from athletes within a range of ages including the athlete's age.

14. A method for evaluating the athleticism of an athlete in soccer, the method comprising: measuring the athlete's performance in at least two different athletic performance tests related to soccer to define a result for each performance test; comparing the result for each performance test to a distribution of test results of athletic data for athletes similar to the athlete and determining a percentile ranking for each result for the performance test; converting each percentile ranking to a fractional event point number for each result; and
combining the fraction event point numbers and using a scaling factor to produce an athleticism rating score the athlete in soccer.

15. The method of claim 14, wherein the percentile rankings for each result for the performance test are progressive.

16. The method of claim 14, wherein the percentile ranking for each result for the performance test is capped at a floor value and a ceiling value.

17. The method in of claim 14, wherein measuring the athlete's performance comprises: measuring a vertical jump height of said athlete; measuring a time for a recovery test; measuring a sprint time of said athlete over a predetermined distance; and
measuring a cycle time of said athlete around a predetermined course.

18. The method of claim 17, wherein measuring the athlete's performance comprises: measuring a body weight of said athlete; and calculating a peak power based on said measured body weight and said no-step vertical jump height.

19. The method of claim 17, wherein the measuring a cycle time of said athlete around a predetermined course is an arrowhead agility drill.

20. The method of claim 17, wherein the recovery test is a Yo Yo Intermittent Recovery Test.
